(19) United States
(12) Patent Application Publication
(10) Pub. No.: US 2003/0143298 A1
(43) Pub. Date: Jul. 31, 2003

(54) Injection molding nozzle

(76) Inventor: Paul R. Blais, South Burlington, VT (US)

Correspondence Address: HUSKY INJECTION MOLDING SYSTEMS, INC, 288 NORTH ROAD, MILTON, VT, 05468, US

(21) Appl. No.: 10/058,922

(22) Filed: Jan. 30, 2002

(51) Int. Cl. B29C 45/23

(52) U.S. Cl. 425/130; 425/549; 425/566; 425/DIG. 47

(57) ABSTRACT

An injection molding nozzle is provided having a first sealing member to substantially eliminate the leakage of molten material from around the injection nozzle. A second sealing member is configured to substantially reduce the leakage of a pressurized fluid, such as air, which may be used to open and close a valve stem associated with the injection nozzle.

### BACKGROUND OF THE INVENTION

1. Field of the Invention

This invention relates to an injection molding nozzle used in conjunction with an injection molding machine. More specifically, the invention relates to a substantially leak free injection molding nozzle comprising an air operated piston connected to a movable valve stem, with the injection molding nozzle having improved sealing properties therein.

2. Summary of the Prior Art

An injection molding apparatus may include a heated hot runner manifold for the distribution of a molten material to at least one injection nozzle. Each injection nozzle may be associated with one or more mold cavities, whereby the molten material is transferred to the mold cavity through a gate orifice located at a distal end of the nozzle. During an injection cycle, the gate orifice may be selectably open and closed to start and stop the flow of molten material to the respective mold cavity.

The current state of the art has focused primarily on two types of gating arrangements. The first type is called thermal gating where the molten material is allowed to solidify adjacent the gate orifice thereby sealing off the injection nozzle at the end of the injection cycle. The second type is called valve gating in which an elongated valve stem, usually running co-axially the length of the injection nozzle, is moved in a back and forth motion to open an close the gate orifice. While myriad means to move the valve stem have been developed, the most popular method has centered on the use of pressurized air supplied to a double acting piston which is affixed to the opposite end of the valve stem. With this arrangement, house air, usually around 70 psi, is selectably supplied to a respective side of the piston to extend or retract the valve stem.

U.S. Pat. No. 5,374,182 to Gessner (incorporated herein by reference) shows a manifold/nozzle arrangement where the manifold bushing 130 is inserted into a bore in the heated manifold 138 and is secured to a cylinder housing 136 by a nut 158 located on a threaded portion of the manifold bushing 130. The assembly is allowed to move during thermal expansion as the system heats up, thereby reducing wear and tear on the valve stem 129. However, due to the threads and imperfect mating surfaces, air may leak around the manifold bushing. In addition, due to fit tolerances between the manifold bushing 130 and the bore 143 in the manifold, and pressurized molten plastic may leak from the manifold 138 thereby requiring constant maintenance.

U.S. Pat. No. 3,849,048 to Bielfeldt (incorporated herein by reference) shows a hydraulically actuated piston housing 31 that takes up the cold clearance to prevent leakage. This piston acts like a spring. Inside the housing 31 is a second hydraulic piston 28 which drives the valve stem 27. The nozzle body 5 is threaded into the manifold insert 1 and therefore thermally expands laterally when the manifold expands. The close proximity of flammable hydraulic oil to the heated manifold 1 means that there is a great risk of fire with this design after the seals have worn.

U.S. Pat. No. 3,716,318 to Erik (incorporated herein by reference) shows a combined nozzle/manifold bushing piece 14 which is inserted through the manifold 15 from the underside and is retained by a threaded piston housing 31. This construction is also disadvantageous in that the nozzle assembly must travel laterally with the manifold as it thermally expands.

Co-pending U.S. patent application Ser. No. 09/550,286 entitled “Improved Hot Runner Valve Gate Piston Assembly” (incorporated herein by reference) discloses an improved valve gate piston assembly for use in hot runner molds in which only part of the compressive forces between the manifold and the backing plate are transmitted to the piston cylinder to maintain the air seal against the mold plate. The piston cylinder preferably uses an integral spring means to reliably seal the piston/cylinder assembly.

Other problems encountered with current injection molding nozzles include air leakage at the back-up pad/cylinder housing and between the threads on the jam nut and the injection nozzle. Induced stresses from the jam nut reduce the maximum injection pressure the injection nozzle can withstand, thereby adversely limiting the acceptable operating range for a given nozzle size.

### SUMMARY OF THE INVENTION

According to one general aspect of the present invention, fluid leakage from an injection nozzle is substantially reduced by an nozzle assembly comprising a piston disposed in a cylinder housing, the piston operatively affixed to a proximal end of an elongated valve stem, the valve stem having a distal end adjacent to a gate orifice to selectably start and stop the flow of hardenable material to a mold cavity. The injection molding nozzle further includes an elongated manifold bushing having a valve stem guidance portion and a bushing channel formed therein, the manifold bushing having a proximal end that is adjacent the guidance portion extending into the cylinder housing and further contacting the piston when the valve stem is placed in a position to stop the flow of hardenable material. A back-up pad is also provided that is adapted to sealingly abut a manifold and a shoulder of the manifold bushing, with the back-up pad being affixed to the elongated manifold bushing by a retaining ring. A sealing means configured to substantially reduce the leakage of the hardenable material from around the manifold bushing is disposed in a groove adjacent the manifold bushing.

According to another general aspect of the present invention, an injection molding machine having a source of pressurized molten material for the formation of a molded product is provided comprising a heated manifold disposed between a backing plate and a mold cavity, the manifold has a melt channel formed therein which is held in fluid communication with the source of molten material for the communication of the molten material to an injection nozzle associated with the mold cavity. A valve stem is operatively disposed in the injection nozzle, and the valve stem is affixed to a movable piston to selectably open and close a gate orifice associated with the injection nozzle. A back-up pad is disposed between the manifold and the backing plate, and the back-up pad sealingly abuts a surface of the backing plate and the back-up pad is further affixed to the injection nozzle next to the piston. A sealing member is disposed between the injection nozzle and the back-up pad, and the sealing member is configured to substantially reduce the leakage of a pressurized fluid.

According to yet another general aspect of the present invention, an injection molding nozzle for communication of a hardenable material to a mold cavity is provided comprising a piston means disposed in a cylinder housing means, said piston means is operatively affixed to a proximal end of a valving means, the valving means having a distal end adjacent an orifice means to selectably start and stop the flow of hardenable material to the mold cavity. A manifold bushing means is provided that has a valving means guidance portion and a bushing channel means formed therein, the manifold bushing means has a proximal end adjacent the guidance portion means and extends into the cylinder housing means and also contacts the piston means when the valving means is positioned to stop the flow of hardenable material. A pad means, adapted to sealingly abut a manifold and a shoulder of the manifold bushing means is further provided, the pad means is affixed to the bushing means by a retaining means. A sealing means is provided to substantially reduce the leakage of the hardenable material from around said manifold bushing means.

Further objects and advantages of the present invention will appear hereinbelow.

### BRIEF DESCRIPTION OF THE DRAWINGS

FIG. 1 is a cross-sectional view of an injection molding nozzle in accordance with a preferred embodiment of the present invention;

FIG. 2 is an enlarged cross-sectional view of an air operated piston in accordance with a preferred embodiment of the present invention;

FIG. 3 is a cross-sectional view of an injection nozzle in accordance with the prior art.

### DETAILED DESCRIPTION OF THE PRESENTLY PREFERRED EMBODIMENTS

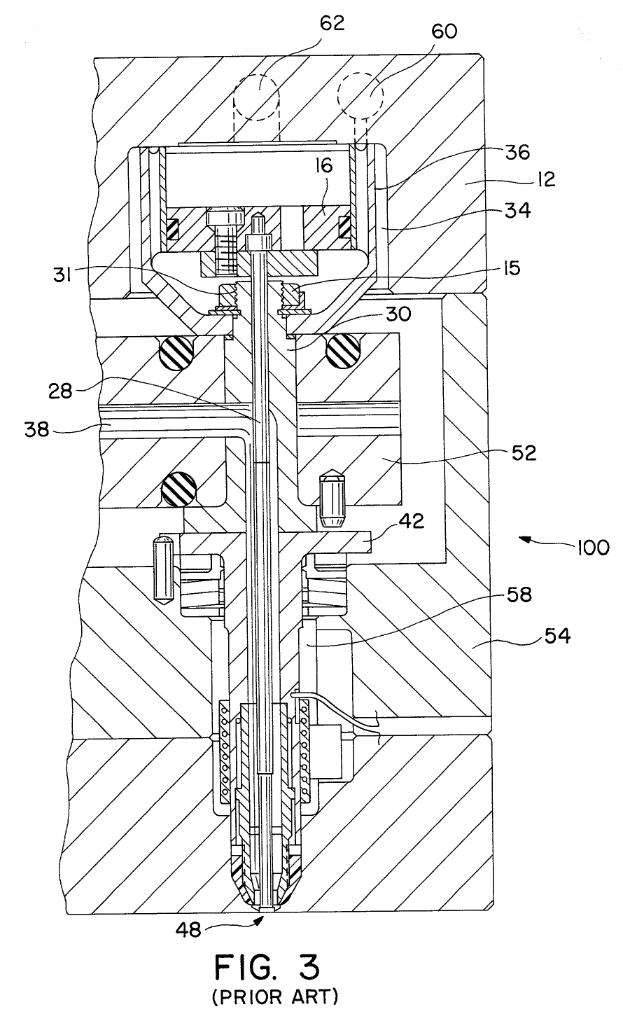

Referring first to FIG. 3 which shows an injection molding nozzle 100 in accordance with the prior art. A manifold bushing 30 is disposed in a bore of a heated manifold 52. A threaded portion 31 of the manifold bushing protrudes through the manifold and into a cylinder housing 36. A nut 15 is threaded onto the threaded portion 31 of the manifold bushing 30 to affix the cylinder housing to the bushing 30 and the manifold 52.

An air-operated, double-acting piston 16 is disposed in the cylinder housing 36, and the cylinder housing 36 is disposed in a backing plate aperture 34 formed in a backing plate 12. An elongated valve stem 28 is operatively affixed to the piston 16 and the valve stem 28 extends co-axially through the manifold bushing to a gate orifice 48. The manifold bushing 30 sealingly abuts an elongated nozzle bushing 42, the nozzle bushing 42 being placed in a mold plate cavity 58 and held in fluid communication with the manifold bushing 30 by a mold plate 54. With this prior art arrangement, pressurize air is provided to the cylinder housing 36 by extension air inlet 62 to extend the valve stem 28 to a closed position. To move the valve stem 28 to an open position, pressurized air is provided to the cylinder housing 36 by a retraction air inlet 60.

The above described injection molding nozzle arrangement can be improved. For example, pressurized molten material may leak from around the manifold bushing 30 from manifold channel 38. This would frequent maintenance and associated downtime of the injection molding machine. In addition, the pressurized air supplied to the piston 16 may leak between the threads and nut 15 interface as well as under the surface of the nut 15. Excessive air leakage can be costly and increases the cost of operating the injection molding machine. Also, if the nut 15 is torqued too tightly, the manifold bushing 30 may squeeze the valve stem 28 and cause it to seize.

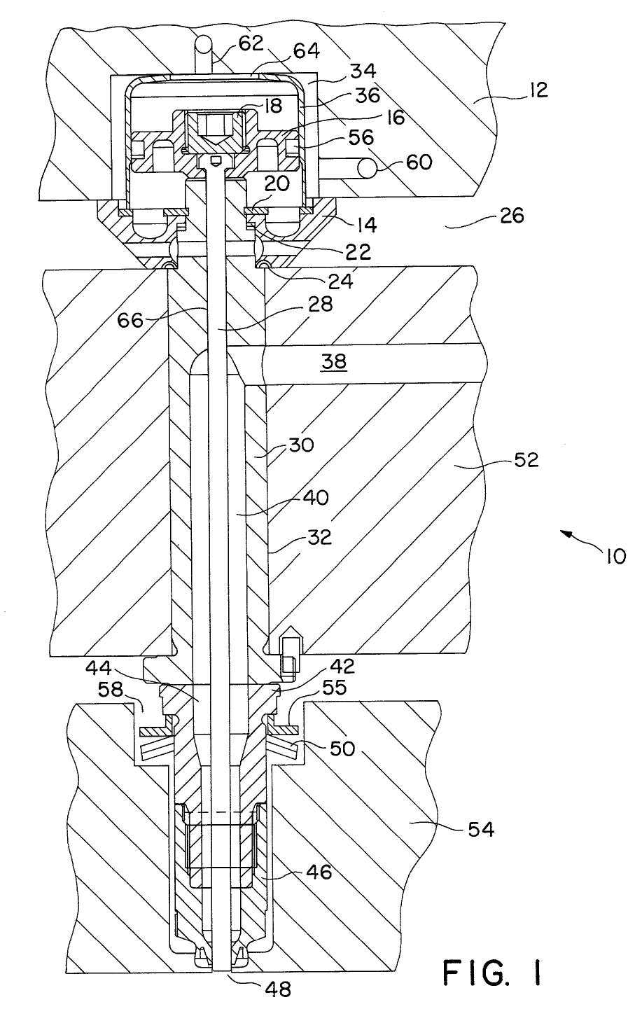

Referring now to FIG. 1, where like items have like numerals, an injection molding nozzle assembly 10 in accordance with a preferred embodiment of the present invention is shown. The manifold bushing 30 is disposed in a manifold aperture 32, and protrudes from a top surface of the manifold 52. A bushing channel 40 formed in the manifold bushing 30 is held in fluid communication with a manifold channel 38 formed in the manifold 52. The manifold bushing 30 further comprises a valve stem guidance portion 66, which is an aperture that fits relatively tightly around the valve stem 28.

Disposed between the backing plate 12 and the manifold 52 is a back-up pad 14 which creates an insulative air gap 26 between the backing plate 12 and manifold 52. The back-up pad 14 is disposed co-axial to the manifold bushing 30, and in the preferred embodiment, the back-up pad 14 fits around the protruding portion of the manifold bushing 30. The back-up pad 14 is secured to the manifold bushing 30 by a snap-on retaining ring 20 provided in a groove located in the manifold bushing 30. However, alternate means of attachment may include threads, pinning, staking, welding, brazing, gluing or the like. The top surface of the back-up pad 14 sealingly abuts a bottom surface of the backing plate 12. This seal area is preferably configured to become even more robust and provide increased sealing pressures due to thermal expansion of the injection nozzle 10.

Disposed in the backing plate aperture 34 is the cylinder housing 36 which comprises a cylinder inlet 64 which is in fluid communication with extension air inlet 62. In the preferred embodiment, the backing plate aperture 34 is larger than the cylinder housing 36 to allow for thermal expansion and movement of the injection nozzle assembly 10.

The piston 16 is disposed in the cylinder housing 36 to selectably move the valve stem 28 to an open or closed position. Valve stem 28 is inserted through the piston 16 and affixed thereto by a set screw 18. A piston seal 56 is disposed in a groove formed in the periphery of the piston 16.

The nozzle bushing 42 is disposed in a mold plate cavity 58 formed in the mold plate 54, and sealingly abuts a lower end of the manifold bushing 30, with bushing channel 40 in fluid communication with a nozzle channel 44 formed in the nozzle bushing 42. A resilient member 50 and a ring 55, are configured to provide a sealing force between the manifold bushing 30 and the nozzle bushing 42. In the preferred embodiment, the resilient member 50 comprises a pair of belville springs or the like configured to withstand high temperatures and the forces associated with thermal expansion of the nozzle assembly 10. A nozzle tip 46 is affixed to the lower end of the nozzle bushing 42 and receives the distal end of the valve stem 28 adjacent the gate orifice 48.

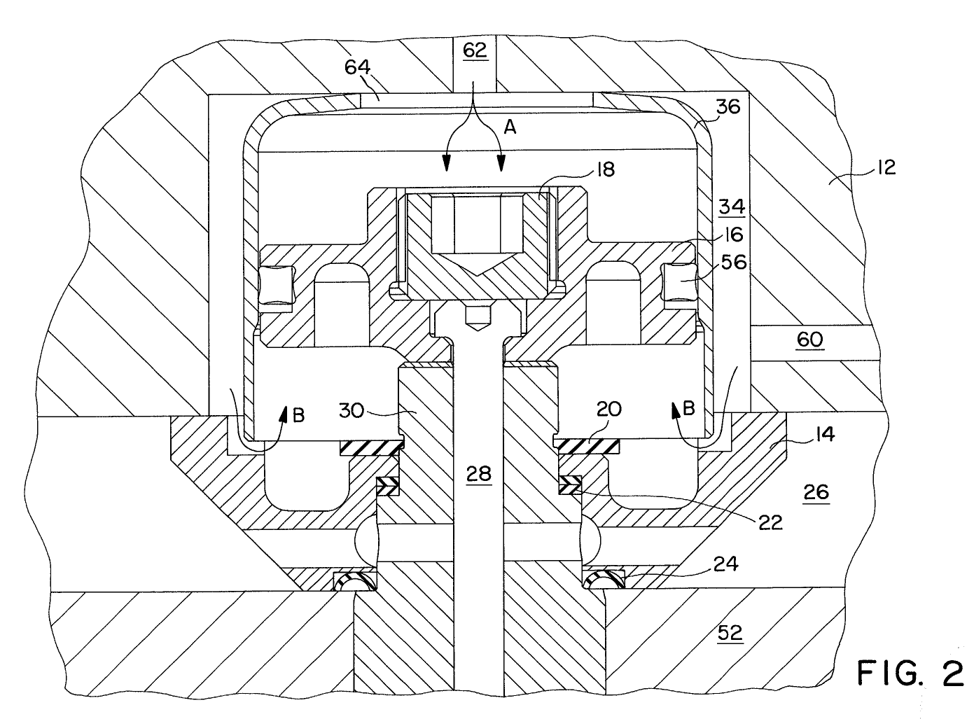

Referring now to FIG. 2 (where like items have like numerals) which shows an enlarged cross-sectional view of the cylinder/piston assembly in accordance with a preferred embodiment. Disposed in a groove formed between the manifold bushing 30 and the back-up pad 14 is a sealing member 22 that is configured to reduce air leakage from around the manifold bushing 30. In the preferred embodiment, the sealing member 22 is preferably a high temperature, graphite based seal that deforms under pressure to provide a more reliable seal during thermal expansion of the injection molding nozzle assembly 10. Specifically, a graphite seal using the tradename GRAFOIL™ has proven to work quite well and is able to withstand temperatures up to 1000° F. However, alternative sealing arrangements such as high temperature o-rings, teflon seals or the like may be used.

A flexible seal 24 is disposed in a groove formed in the back-up pad 14 adjacent the manifold aperture 32/manifold bushing 30 interface where the manifold bushing 30 protrudes from the top surface of the manifold 52. The flexible seal 24 is configured to substantially reduce the leakage of molten material from between the manifold aperture 32/manifold bushing 30 interface. In the preferred embodiment, the flexible seal 24 is made from a ring of 304 stainless steel that is formed with a semicircular cross-section. This configuration has proven to provide a reliable seal throughout the operating range of the injection molding nozzle. However, alternative sealing arrangements such as high temperature o-rings, graphite seals, crush seals, teflon seals and the like may be used.

To extend the valve stem 28 to a closed position, pressurized air is provided to cylinder housing 16 through extension air inlet 62 as shown by arrow A. The pressure differential in the cylinder housing causes the piston 16 to move downward thereby closing the gate orifice 48 and stopping the flow of molten material to the mold cavity.

To move the piston 16 to a retracted position, pressurized air is provided to the under side of the piston 16 through retraction air inlet 60 formed in backing plate 12. The cylinder housing 36 in the preferred embodiment abuts a surface of the back-up pad 14 and sealingly abuts a surface of the backing plate 12. In the preferred embodiment, the retraction air inlet 60 is also in fluid communication with the backing plate aperture 34, and pressurized air enters the cylinder housing 36 through notches in the back-up pad 14, as shown by arrows B. With a positive pressure differential under the piston 16, the piston 16 will stroke upward thereby moving the valve stem 28 to an open position where molten material is allowed to flow into the mold cavity.

With this arrangement, air leakage from between the back-up pad 14 and the manifold bushing 30 has been substantially eliminated. For a given size injection molding nozzle, the maximum operating injection pressure has been increased and the cost to produce the nozzle has been reduced. Leakage of the molten material between the manifold bushing 30 and the manifold 52 has also been substantially reduced, which reduces waste and maintenance cost associated with the injection molding machine.

It is to be understood that the invention is not limited to the illustrations described herein, which are deemed to illustrate the best modes of carrying out the invention, and which are susceptible to modification of form, size, arrangement of parts and details of operation. The invention is intended to encompass all such modifications, which are within its spirit and scope as defined by the claims.

What is claimed is:

1. An injection molding nozzle for communication of a hardenable material to a mold cavity, comprising:
a piston disposed in a cylinder housing, said piston operatively affixed to a proximal end of an elongated valve stem, said valve stem having a distal end adjacent a gate orifice to selectably start and stop the flow of hardenable material to the mold cavity;
a manifold bushing having a valve stem guidance portion and a bushing channel formed therein, said manifold bushing having a proximal end adjacent said guidance portion and disposed with respect to said cylinder housing to contact said piston when said valve stem is placed in a position to stop the flow of hardenable material;
a back-up pad, adapted to sealingly abut a manifold and a shoulder of said manifold bushing, said back-up pad being affixed to said manifold bushing by a retaining ring,
a sealing device configured to substantially reduce the leakage of the hardenable material from around said manifold bushing.

2. The injection molding nozzle of claim 1, further comprising a sealing member provided between said manifold bushing and said backup pad to substantially reduce the leakage of a fluid from said cylinder housing.

3. The injection molding nozzle of claim 2, wherein said fluid is one selected from the group consisting of pressurized air, hydraulic oil, oil, liquid, and water.

4. The injection molding nozzle of claim 2, wherein said sealing member is one selected from the group consisting of an o-ring, a high temperature seal, a resilient graphite seal, and a metallic seal.

5. The injection molding nozzle of claim 2, wherein said sealing member seats against a shoulder formed in said manifold bushing and a shoulder formed in said back-up pad.

6. The injection molding nozzle of claim 2, wherein, during operation, thermal expansion of said manifold bushing acts to increase the sealing pressure on said sealing member.

7. The injection molding nozzle of claim 1, wherein said cylinder housing is positioned in a backing plate cavity formed in a backing plate.

8. The injection molding nozzle of claim 7, wherein said backing plate cavity is configured to allow said cylinder housing to move due to thermal expansion.

9. The injection molding nozzle of claim 7, wherein said backing plate cavity is further configured to admit a pressurized fluid to said cylinder housing to move said valve stem to an open position.

10. The injection molding nozzle of claim 1, wherein said cylinder housing further comprises an air inlet configured to admit pressurized air into said cylinder housing to move said piston and position said valve stem in a closed position.

11. The injection molding nozzle of claim 1, wherein said cylinder housing further comprises an air inlet configured to admit pressurized air into said cylinder housing to move said piston and position said valve stem in an open position.

12. The injection molding nozzle of claim 1, wherein said cylinder housing further comprises a first inlet configured to admit a pressurized fluid to selectably move said valve stem to a closed position, and a second inlet configured to admit said pressurized fluid to selectably move said valve stem to an open position.

13. The injection molding nozzle of claim 1, wherein said back-up pad sealingly abuts a backing plate.

14. The injection molding nozzle of claim 13, wherein said back-up pad is provided co-axially with said manifold bushing.

15. The injection molding nozzle of claim 14, wherein said back-up pad is located between said backing plate and a manifold.

16. The injection molding nozzle of claim 15, wherein said back-up pad is configured to substantially thermally isolate said manifold from said backing plate.

17. The injection molding nozzle of claim 1, further comprising a nozzle bushing provided between said manifold bushing and the gate orifice, said nozzle bushing being in fluid communication with said manifold bushing.

18. The injection molding nozzle of claim 17, further comprising a biasing means associated with said nozzle bushing and configured to provide a sealing force between said manifold bushing and said nozzle bushing.

19. The injection molding nozzle of claim 17, further comprising a heater in thermal communication with said nozzle bushing.

20. The injection molding nozzle of claim 17, further comprising a nozzle tip provided between said nozzle bushing and said gate orifice.

21. The injection molding nozzle of claim 20, further comprising a heater in thermal communication with said nozzle tip.

22. The injection molding nozzle of claim 1, further comprising a heater in thermal communication with said manifold bushing.

23. The injection molding nozzle of claim 22, wherein said heater is located in a helical groove formed in said manifold bushing.

24. The injection molding nozzle of claim 1, wherein said sealing means comprises a resilient ring.

25. The injection molding nozzle of claim 24, wherein said resilient ring is made from one material selected from the group consisting of stainless steel, teflon, rubber, silicone, copper alloy, bronze alloy and aluminum alloy.

26. The injection molding nozzle of claim 1, wherein said sealing means is provided in a groove formed in said back-up pad.

27. The injection molding nozzle of claim 1, wherein said sealing means is provided adjacent an outside diameter of said manifold bushing.

28. An injection molding machine for processing molten material, comprising:
a manifold disposed between a backing plate and a mold cavity, said manifold having a melt channel formed therein in fluid communication with an injection nozzle associated with the mold cavity;
a valve stem operatively disposed in the injection nozzle, said valve stem being affixed to a movable piston to selectably open and close a gate orifice associated with said injection nozzle;
a back-up pad disposed between said manifold and the backing plate, said back-up pad sealingly abutting a surface of the backing plate, said back-up pad being affixed to said injection nozzle adjacent said piston;
a sealing member disposed between the injection nozzle and said back-up pad, said sealing member configured to substantially reduce the leakage of a pressurized fluid between said back-up pad and the injection nozzle.

29. The injection molding machine of claim 28, further comprising a flexible seal disposed around the periphery of said injection nozzle configured to substantially reduce the leakage of the molten material.

30. The injection molding machine of claim 29, wherein said flexible seal comprises a metallic seal configured to withstand pressure and temperature associated with the injection molding machine.

31. The injection molding machine of claim 29, wherein said flexible seal is disposed in a groove formed in said back-up pad.

32. The injection molding machine of claim 31, wherein said flexible seal is further disposed along a shoulder formed in said injection nozzle.

33. The injection molding machine of claim 32, wherein said shoulder forms a surface on said injection nozzle that is coplanar with a top surface of said manifold.

34. The injection molding machine of claim 28 further comprising a cylinder housing disposed in a backing plate cavity formed in the backing plate, said cylinder housing configured to sealingly house said piston.

35. The injection molding machine of claim 34 further comprising an extension air inlet in fluid communication with said piston.

36. The injection molding machine of claim 35, wherein said extension air inlet is in fluid communication with a cylinder inlet formed in a wall of said cylinder housing.

37. The injection molding machine of claim 34 further comprising a retraction air inlet in fluid communication with said piston.

38. The injection molding machine of claim 28 wherein said valve stem is affixed to said piston by a set screw.

39. The injection molding machine of claim 28, wherein said piston abuts a top surface of said injection nozzle when said piston is at the end of said piston's downward stroke.

40. The injection molding machine of claim 28, wherein said sealing member comprises a compressible graphite seal.

41. The injection molding machine of claim 28, wherein said back-up pad is affixed to a top distal end of said injection nozzle by a retaining ring.

42. An injection molding nozzle for communication of a hardenable material to a mold cavity, comprising:
a piston means disposed in a cylinder housing means, said piston means operatively affixed to a proximal end of a valving means, said valving means having a distal end adjacent an orifice means to selectably start and stop the flow of hardenable material to the mold cavity;
a manifold bushing means having a valving means guidance portion and a bushing channel means formed therein, said manifold bushing means having a proximal end adjacent said guidance portion extending into said cylinder housing means and contacting said piston means when said valving means is positioned to stop the flow of hardenable material;
a pad means, adapted to sealingly abut a manifold and a shoulder of said manifold bushing means, said pad means being affixed to said bushing means by a retaining means,
sealing means configured to substantially reduce the leakage of the hardenable material from around said manifold bushing means.

43. The injection molding nozzle of claim 42, further comprising a second sealing means to substantially reduce the leakage of a fluid from said cylinder housing means.

44. The injection molding nozzle of claim 43, wherein said fluid is one selected from the group consisting of pressurized air, hydraulic oil, oil, liquid and water.

45. The injection molding nozzle of claim 43, wherein said second sealing means is one selected from the group consisting of an o-ring, a high temperature seal, a resilient graphite seal and a metallic seal.

46. The injection molding nozzle of claim 43, wherein said second sealing means seats against a shoulder formed in said manifold bushing means and a shoulder formed in said pad means.

47. The injection molding nozzle of claim 43, wherein during operation, thermal expansion of said manifold bushing means increases the sealing pressure on said second sealing means.

48. The injection molding nozzle of claim 42, wherein said cylinder housing means is positioned in a cavity means formed in a backing plate.

49. The injection molding nozzle of claim 48, wherein said cavity means is configured to allow said cylinder housing means to move due to thermal expansion.

50. The injection molding nozzle of claim 49, wherein said cavity means is further configured to admit a pressurized fluid to said cylinder housing means to move said valving means to an open position.

51. The injection molding nozzle of claim 42, wherein said cylinder housing means further comprises an air inlet means configured to admit pressurized air into said cylinder housing means to move said piston means and position said valving member to a closed position.

52. The injection molding nozzle of claim 42, wherein said cylinder housing means further comprises an air inlet means configured to admit pressurized air into said cylinder housing means to move said piston means and position said valving means to an open position.

53. The injection molding nozzle of claim 42, wherein said cylinder housing means further comprises a first inlet means configured to admit a pressurized fluid to selectably move said valving means to a closed position and a second inlet means configured to admit said pressurized fluid to selectably move said valving means to an open position.

54. The injection molding nozzle of claim 42, wherein said pad means sealingly abuts a backing plate.

55. An injection molding nozzle disposed in an injection molding machine comprising:
a nozzle tip affixed to a distal end of a nozzle bushing, said nozzle tip adjacent a gate orifice;
a manifold bushing in fluid communication with said nozzle bushing and in fluid communication with a manifold passageway;
a back-up pad affixed to said nozzle bushing;
a movable valve stem having a first end protruding from a top end of said nozzle bushing and a second end adjacent said gate orifice;
a piston disposed in a cylinder housing affixed to said first end of said valve stem; and,
a sealing member disposed between said back-up pad and said nozzle bushing configured to substantially reduce the leakage of a pressurized fluid transmitted to move said piston.

56. The injection molding nozzle of claim 55 further comprising a flexible sealing member disposed along the periphery of said nozzle bushing configured to substantially reduce the leakage of molten material from said injection molding nozzle.
